(19) United States
(12) Patent Application Publication
(10) Pub. No.: US 2005/0214502 A1
(43) Pub. Date: Sep. 29, 2005

(54) Removable tile spacer

(76) Inventor: Lee Anthony Westthorp, Glenelg East (AU)

Correspondence Address: COLEMAN SUDOL SAPONE, P.C., 714 COLORADO AVENUE, BRIDGE PORT, CT, 06605-1601, US

(21) Appl. No.: 10/519,344

(22) PCT Filed: Jun. 25, 2003
(86) PCT No.: PCT/AU03/00803

§ 371 Date: Dec. 24, 2004

(30) Foreign Application Priority Data
Jun. 25, 2002 (AU) PS 3231

(51) Int. Cl. B32B 5/00

(52) U.S. Cl. 428/98

(57) ABSTRACT

A tile spacer holder including two opposed tile spacers supported in a spaced apart position by an interconnecting member, the holder configured to provide for finger gripping between the two opposed tile spacers. This is generally provided in cuboidal form with sides of equal length each supporting a spacer. The spacers might be provided as three pairs each providing for spacing apart of tiles to a common gap. Preferably the tile space holder has an open cup shaped form that allows for moulding in a two piece die.

### FIELD OF THE INVENTION

This invention relates to a tile spacer and in particular to a spacer that facilitates removal after use.

### BACKGROUND OF THE INVENTION

Laying of tiles, such as ceramic tiles, is a task that requires a great deal of attention to detail. Mostly ceramic tiles are laid in rows that are evenly spaced apart on planar surfaces such as floors or walls. On inspection, even casual inspection, any irregularity in spacing is readily perceived. To maintain regularity of spacing spacers are inserted between tiles to assist with maintaining all tiles a common distance apart. Spacers that are commonly used are made of a rigid plastics material and are typically in two forms being either an elongate piece that fits between adjacent sides of two tiles or a cross-shaped piece that fits at corners of four adjacent tiles.

Various spacers sizes are used depending on the fineness of the desired join. The majority of spacers have dimension ranging between 2 mm and 6 mm, but larger spacers are known. Larger joints are typically required where there is variation in dimensions of individual tiles such as is the case with quarry tiles or natural stone pieces such as slate.

The spacers are inserted between tiles during laying and are left in the gaps whilst the adhesive is allowed to set. It is desirable to remove the spacers after the adhesive has set but often it is not possible to take all the spacers out of the gaps and removal of spacers is generally difficult because usually there is a very close fit to adjacent tiles compounded by the interference of adhesive that has set. The height of spacers is generally made so that in use they do not come up above the height of the tiles. This arrangement is practised so that it is possible to leave all spacers in the gaps or at least those that are more difficult to remove. The gaps are usually filled with a grout, however where there is an underlying spacer the flow of grout can be impeded, and importantly some time after finishing, cracking of the grout can occur which can be unsightly at best or which may all allow ingress of water and thereby has the potential for damage to the bonding of the tiles over the medium to long-term.

There have been a number of attempts to provide for a means to facilitate removal of spacer from tiles. An example of a proposal to provide for an exposed portion for gripping and removal can be seen in U.S. Pat. No. 4,793,068 to Golkar, which shows the use of a stem projecting upwardly from the spacer. The Golkar spacer is additionally tapered downwardly to allow for rocking of the spacer by manipulating the stem to loosen the spacer before removal. The degree to which some spacers are wedged or adhered in place is still such that a stem does not provide adequate frictional engagement for the spacer to be pulled out by hand or if a hand tool such as a pair of pliers is used there is a strong risk of the stem breaking off before removal is effected. Additionally there is still a need for a supplier to provide for a range of spacers to cater for commonly used spacer widths.

One suggestion in U.S. Pat. No. 5,288,534 by Tavshanjian provides for a double sided spacer with two different configurations mounted on to opposite sides of a disk shaped platform. The two configurations are of the same width, and are thus intended to provide for only one size width of spacer so that separate spacers must be provided for each separate width desired between the tiles. The spacer additionally still has the deficiency of being difficult to remove.

### SUMMARY OF THE INVENTION

The present invention results in a tile spacer holder with provides for spaced apart and opposed tile spacers, which are spaced apart so that the holder can be gripped between the opposed tile spacers to manually remove the spacer.

The spacer holder in one form of the invention comprises at least two opposed tile spacers supported apart by a distance being at least approximately equal to a length of the spacer to provide sufficient purchase for removal of the spacer. The opposed spacers might be spaced apart a distance of greater than about 1 cm, perhaps greater than 1.5 cm or preferably greater than about 2 cm. One specific form of the invention has the opposed spacers spaced apart by about 2.4 cm.

The above distances in another form of the invention need not be equal to the length of the opposed spacers, however where the spacing of the two opposed spacer is at a distance of approximately one length of each spacer there is an opportunity to provide one or more spacers also positioned between the two opposed spacers on the one holder, and also makes efficient use of the dimensions of the holder.

The tile spacers of the holder preferably include both a cross shaped spacer and a linear spacer. The linear spacer is usually in the form of a protruding web extending laterally from the holder, a length of the linear spacer being defined between two ends of the spacer. A depth of the spacer being defined by the extent to which the spacer protrudes from its support, and a width being defined by the distance between opposing sides of the web. A cross shaped spacer in a typical configuration takes the form of two notionally bisecting linear spacers that form a cross which might be said to therefore have four arms extending from the intersection, each arm being of equal length, the length of the arm taken between the intersection and a free end. The length of the cross shaped spacer is about two times the length of an individual arm and in a preferred embodiment is the same length as the opposed linear spacer.

Pairs of cross shaped and straight spacers might be provided, and in one form three such pairs might be provided in a generally cube configuration. In the later configuration all spacers have similar dimensions of length. Instead of a cube shape another three dimensional shaped holder might also be provided such as icosahedral where each or some of the planes of the icosahedral presents a tile spacer. A rectilinear holder such as a cube, or at least a three dimensional shape where the planes of the shape are aligned in one direction or transverse thereto, however, is preferred from a manufacturing perspective. Although where the above arrangement of planes is not that simple, manufacturing may be facilitated by making the holder in two identical parts that can be snap fitted together. The holder instead of being a cube might have two opposed faces that are pentagonal with five generally square or rectangular faces extending between sides of the opposed pentagonal faces, the square or rectangular faces each presenting a spacer. The opposed pentagonal faces may or may not also present a spacer. It will be understood that the term opposed spacers need not necessarily be understood as meaning that the spacers parallel one to the other, but simply generally opposing, as would be understood from the relative juxtaposition in the pentagonal arrangement described above.

The spacers of the holder are held in place by an interconnecting member. Typically the tile spacer holder will be moulded as one piece although it is feasible to provided for tile spacers reversibly attachable to the interconnecting member. Such reversible connection feature is resistant to disconnection by lateral movement, and might take the form of a tongue and groove connection whereby the spacer is slid into place within a groove.

The interconnecting member preferably provides for an inflexible interconnection so that sides of the tile holder can be gripped firmly to remove the spacer after tiles have been adhered.

The interconnecting member might be made of a plurality of interconnecting webs extending between the at least two spacers. The interconnecting webs are generally aligned relative to one another and the webs of the spacers in one direction or orthogonal thereto. There being no more than one web aligned transverse to the one direction at a particular part of the holder. The above arrangement provides for ready moulding by a two part mould. Thus at most there is only one transverse interconnecting web portion at any part of the holder with the remainder aligned in a withdrawal direction of any moulds. Similarly any cross shaped spacers that are present on the side walls are aligned so that one pair of arms of the cross are aligned with a directional of withdrawal and the other pair of arms are positioned transverse thereto.

For the purposes of this specification the word “comprising” means “including but not limited to”, and the word “comprises” has a corresponding meaning. Also a reference within this specification to a document is not to be taken as an admission that the disclosure therein constitutes common general knowledge in Australia.

For a better understanding the invention will now be described with reference to the drawings wherein

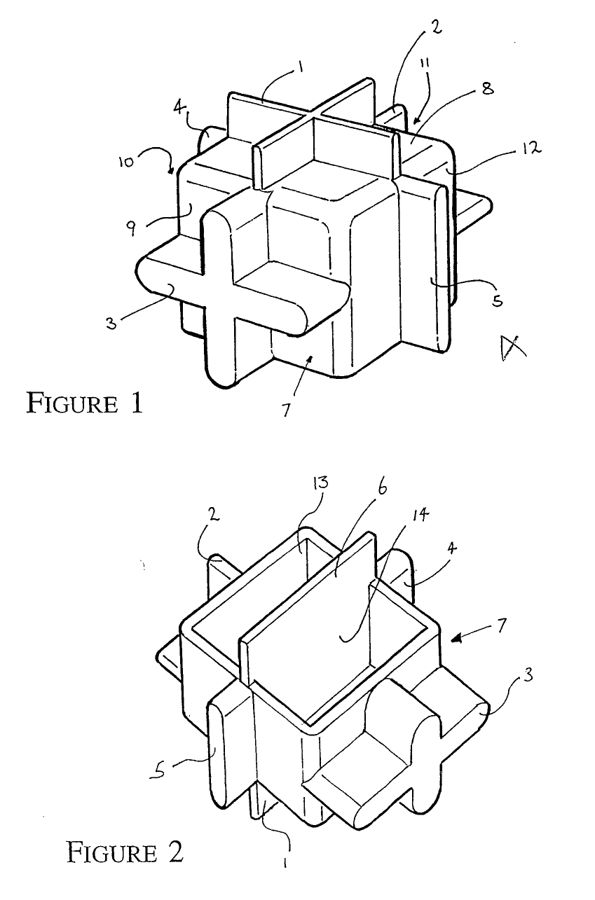

FIG. 1 is a perspective view from the outside of a first embodiment of the invention,

FIG. 2 is a perspective view from the inside of the first embodiment

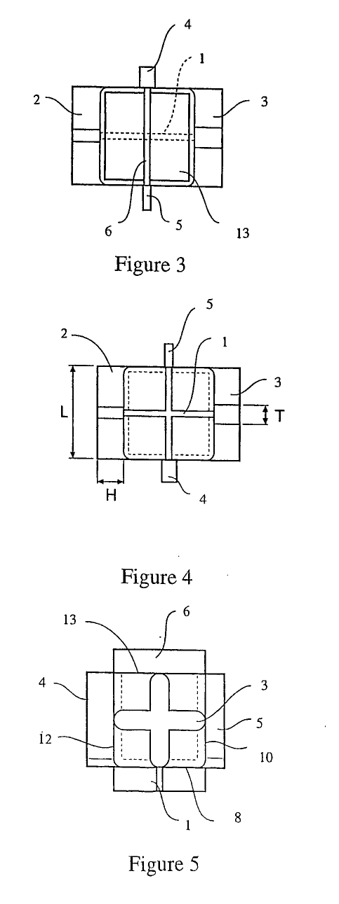

FIG. 3 is an underneath view of the first embodiment,

FIG. 4 is a view from above of the first embodiment, and

FIG. 5 is a side view of the first embodiment.

### DETAILED DESCRIPTION OF THE ILLUSTRATED EMBODIMENT OF THE INVENTION

The illustrated tile spacer holder comprises six spaced apart and opposed tile spacers (1, 2, 3, 4, 5, 6). The tile spacers are supported on a generally cup shaped interconnecting member (7), which assumes a generally cuboidal shape, having a square web of plastics material forming each planar face (8, 9, 10, 11, 12) of the cube apart from one side (13) which is open.

A centrally positioned reinforcing web (14) extends through the depth of the cup shaped interconnecting member providing structural integrity to the cup and the linear spacer (6) supported thereon.

It can be seen that the sides of the interconnecting member are all of equal dimensions and collectively make up the cuboidal shape. In the illustrated embodiment the outside dimensions of sides of the cup shaped interconnecting member are 25 mm, and have a wall thickness of about 2 mm. These dimensions however might be varied to still give a reliable product.

The tile spacers comprise three cross shaped spacers (1, 2, 3) and three linear spacers (4, 5, 6). The linear spacers are 25 mm long (L) with a height of 7 mm (H) and have a thickness (T) that is one of three sizes, namely 2, 3 and 5 mm (for spacers 1, 2 and 3 respectively). The thickness determines the gap between tiles, and the height determines how far down from the top surface of a tile the spacer extends. These dimensions are generally not critical to the invention, but rather are in line with what is currently in usage. The cross shaped spacers might be considered to comprise two orthogonally bisecting linear spacers, which might thus be considered as having two lengths each the length of the linear spacers having free ends and a central portion joined at the intersection of all four arms. Each of the spacers extend across the entire width of a respective face of the cube from which the spacer protrudes so that the ends end at edges of the face, and are supported at their ends by a wall extending orthogonally backwards therefrom. In the case of spacers supported by faces (8, 9, 10, 11, 12) of the cube shaped interconnecting member that are defined by webs of plastic the spacers are also supported by the webs of plastic. In the case of the face (13) not defined by a web of plastics the linear spacer is fully supported along its length by the reinforcing web (14).

It can be seen accordingly that this embodiment of the invention provides for a set of linear and cross shapes spacers with sizes of 2, 3, and 5 mm. These are the most commonly used widths of spacers. A supplier therefore only needs to make one spacer holder to supply the majority of users, and this provides for efficiencies in manufacture and in stock holding of, for example, handyman or trade stores.

The use of the spacer is very similar to that of conventional spacers. The desired cross or linear spacer is inserted between tiles after having been placed on an adhesive bed with appropriate pressure having been applied to enhance the bonding of the tile, one or more spacers are inserted between tiles to set the gaps between tiles, and the adhesive is allowed to set. It will be appreciated that the majority of the spacer holder is held above the level of the surface of the tile.

The removal of the spacer is facilitated by the extent to which the sides of the holder provide for a surface on which fingers of a tiler might grip. A considerable force does need to be exerted to dislodge at least a proportion of the tile spacers from the gaps between tiles after they have been set. Thus in the illustrated embodiment 25 mm×25 mm of griping surface is provided on opposing sides. Moreover the gripping surface is not simply a plain surface on which a finger might slide but the spacers positioned on the sides provides for significant protuberances which enhance the grip for pulling out the spacers. The degree to which the spacers are supported by the interconnecting member ensures also that portions of the spacer do not break off and remain lodged in the gap between tiles.

The illustrated embodiment notwithstanding its complexity is readily made in a two part mould. It can be seen that webs making up the cup shaped interconnecting member and the spacers are aligned in one direction, apart from some webs that are transverse thereto however in any given plan portion of the holder there is no more than one transversely extending web. Referring to FIGS. 1 and 2. The line of the one direction is a direction in which a two part mould might be separated, and this is generally in line with, for example, linear spacer (5). It can be seen therefore that webs (9, 10, 11, 12) making up the cube, linear spacers (4 and 5) reinforcing web (14) lower and upper arms of spacers 2 and 3 are all aligned in the one direction. Similarly are the webs of spacers (1), and (6) are also so aligned. Transverse thereto are side arms of spacers (2) and (3), and the upper web (8) of the interconnecting member. It will be seen that whilst a transverse web of plastics is provided over the majority of the holder there is however no more than one over any portion of the holder when viewed in plan from above.

Various features of the invention have been particularly shown and described in connection with the exemplified embodiments of the invention, however, it must be understood that these particular arrangements merely illustrate and that the invention is not limited thereto and can include various modifications falling within the spirit and scope of the invention.

1. A tile spacer holder including two opposed tile spacers supported in a spaced apart position by an interconnecting member, the holder configured to provide for finger gripping between the two opposed tile spacers.

2. A tile spacer holder as in claim 1 wherein the two opposed tile spacers are supported apart by a distance being at least approximately equal to a length of the spacers.

3. A tile spacer as in either claim 1 wherein the opposed spacers are spaced apart a distance of greater than about 1 cm.

4. A tile spacer as in claim 1 wherein the opposed spacers are spaced apart a distance of greater than about 1.5 cm.

5. A tile spacer as in claim 1 wherein the opposed spacers are spaced apart a distance of greater than about 2 cm.

6. A tile spacer as in claim 1 wherein the opposed spacers are spaced apart a distance of about 2.4 cm.

7. A tile spacer as in claim 1 wherein the opposed spacers are spaced apart at a distance of approximately the one length of each spacer.

8. A tile spacer as in claim 7 wherein one or more further spacers also positioned between the two opposed spacers.

9. A tile spaces as in claim 8 wherein the holder includes both a cross shaped spacer and a linear spacer.

10. A tile spacer as in claim 9 wherein the holder comprises at least one pair of cross shaped and straight spacers wherein the pair has the same width to thereby provide for the same spacing between tiles.

11. A tile spacer as in claim 10 where in the holder comprises three pairs might be provided the holder being generally cuboidal in shape.

12. A tile spacer holder as in claim 1 wherein the tile spacer holder is moulded as one piece.

13. A tile spacer holder as in claim 1 wherein the interconnecting member provides for an inflexible interconnection between the opposed spacers.

14. A tile spacer holder as in claim 1 wherein the interconnecting member is made of a plurality of interconnecting webs extending between the at least two spacers and the interconnecting webs are generally aligned relative to one another and the webs of the spacers in one direction or orthogonal thereto, there being no more than one web aligned transverse to the one direction at a particular part of the holder.

15. A tile spacer holder being generally cuboidal in shape, carrying three pairs of spacers, each pair comprising a cross shaped spacer and a linear spacer, the spacers of the pair having the same width to space apart tiles to a common distance, the spacers supported on an interconnecting member comprising a cuboidal shell comprising six square sides defined by the interconnecting member by a respective web apart from one side of the shell being open into a hollow of the shell, the open end supporting a linear spacer extending outwardly from the interconnecting member being aligned with a planar support web extending into the hollow of the shell to provide resistance to inward pressure from two opposing sides of the cuboidal shell and additionally support the said liner spacer extending outwardly from the open end of the interconnecting member, the cross shaped spacers and linear spacers aligned to bisect the respective square sides of the cuboidal shell on which they are supported.
